(19) United States
(12) Patent Application Publication
(10) Pub. No.: US 2006/0032568 A1
(43) Pub. Date: Feb. 16, 2006

(54) Tire with oxygen scavenging barrier

(76) Inventors: Annette Lechtenboehmer, Ettelbruck (LU); Giorgio Agostini, Colmar-Berg (LU); Filomeno Gennaro Corvasce, Mertzig (LU)

Correspondence Address: THE GOODYEAR TIRE & RUBBER COMPANY;INTELLECTUAL PROPERTY DEPARTMENT 823, 1144 EAST MARKET STREET, AKRON, OH, 44316-0001, US

(21) Appl. No.: 10/916,195

(22) Filed: Aug. 11, 2004

(51) Int. Cl. B60C 1/00

(52) U.S. Cl. 152/510; 152/525; 152/537; 152/564; 152/450

(57) ABSTRACT

The present invention provides a tire comprising a polyester copolymer, the polyester copolymer comprising predominantly polyester segments and an oxygen scavenging amount of polyolefin oligomer segments.

### BACKGROUND OF THE INVENTION

Pneumatic tires include many components made with rubber or rubber compounds that are susceptible to degradation and aging due to oxidation. Typically, rubber compounds in tires include antioxidants to minimize the effects of oxygen on the rubber. Rubber innerliners disposed on the inner surface of a tire are designed to retain inflation air within the tire, and to minimize migration of oxygen into the tire components.

U.S. published patent application No. 2004/0074123 and U.S. Pat. Nos. 6,675,851 and 6,698,483 disclose a rubber-based product usable in a tire, which is composed of a buffer zone and a zone sensitive to oxidation, the buffer zone being capable of trapping oxygen external to the product. The buffer zone contains a composition composed of at least one elastomer containing at least one salt of iron (III) provided to activation oxidation in the composition.

U.S. Pat. Nos. 6,083,585; 6,346,308; and 6,509,436 discloses compositions for scavenging oxygen. These compositions comprise condensation copolymers comprising predominantly polyester segments and an oxygen scavenging amount of polyolefin oligomer segments.

### SUMMARY OF THE INVENTION

The present invention provides a tire comprising an oxygen scavenging barrier, the barrier comprising a polyester copolymer, the polyester copolymer comprising predominantly polyester segments and an oxygen scavenging amount of polyolefin oligomer segments.

### DESCRIPTION OF THE INVENTION

In one embodiment, the tire of the present invention comprises an oxygen scavenging barrier fabricated from a polyester copolymer, the polyester copolymer comprising predominantly polyester segments and an oxygen scavenging amount of polyolefin oligomer segments.

Suitable polyester copolymers comprising predominantly polyester segments and an oxygen scavenging amount of polyolefin oligomer segments are disclosed in U.S. Pat. Nos. 6,083,585; 6,346,308; and 6,509,436, which are fully incorporated herein by reference.

Generally, suitable polyester copolymer comprising predominantly polyester segments and an oxygen scavenging amount of polyolefin oligomer segments include, but are not limited to, those as described in U.S. Pat. Nos. 6,083,585; 6,346,308; and 6,509,436. The polyester copolymers may include copolycondensates of polyesters and hydrocarbons. Such copolycondensates may be produced, for example, by the reactive extrusion of a polyester with a saturated or unsaturated polyolefin or polydiene in the presence of a transition metal catalyst.

Suitable polyesters include linear polyesters of an aromatic dicarboxylic acid component and a diol component. Examples of dicarboxylic acid components include terephthalic acid, isophthalic acid, naphthalenedicarboxylic acid, diphenyl ether carboxylic acid, diphenyl dicarboxylic acid, diphenyl sulfone dicarboxylic acid and diphenoxyethanedicarboxylic acid. Examples of diol components include ethylene glycol, trimethylene glycol, tetramethylene glycol, neopentyl glycol, hexamethylene glycol, cyclohexanedimethanol, tricyclodecanedimethanol, 2,2-bis (4-p-hydroxy ethoxy phenyl) propane, 4,4-bis (p-hydroxy ethoxy) diphenyl sulfone, diethylene glycol and 1,4-butanediol. Examples of polyesters that can be employed in the present invention include polyethylene terephthalate, polybutylene terephthalate, polybutylene terephthalate elastomer, amorphous polyesters, polycyclohexane terephthalate, polyethylene naphthalate, polybutylene naphthalate and mixtures of the foregoing.

Suitable polyolefin or polydienes for use in the copolycondensates include polyolefins and polydienes such as polypropylene, poly(4-methyl)1-pentene and polybutadiene. Suitable hydrocarbons are generally functionalized one or more terminal sites in the hydrocarbon are functionalized. Suitable terminal functional groups include hydroxy, carboxylic acid, carboxylic acid anhydrides, alcohol, alkoxy, phenoxy, amine, and epoxy. The preferred terminal functional groups are hydroxy, carboxylic acid, and amino. Suitable hydrocarbons have a molecular weight range of from about 100 to about 10,000. The preferred polyolefin oligomer starting material is the dihydroxy terminated polybutadiene having a molecular weight in the range of about 100 to 10,000.

The presence of polyolefin or polydiene oligomer segments in the range of about 0.5 weight percent to about 12 weight percent based on weight of the copolycondensate is a typical weight percent usage range. Preferred is the presence of polyolefin or polydiene oligomer segments in the range of about 2 weight percent to about 8 weight percent based on weight of the copolycondensate. Especially preferred is the presence of polyolefin or polydiene oligomer segments in the range of about 2 weight percent to about 6 weight percent based on weight of the copolycondensate.

A typical range for polyolefin or polydiene segments is from about 0.5 weight percent to about 12 weight percent of the total weight of product copolycondensate. A transesterification catalyst, such as a transition metal carboxylate, is employed in the reactive extrusion process in a range of about 10-300 PPM of the mixture in the extruder. Cobalt carboxylates are the preferred transesterification catalysts and especially preferred. A suitable transesterification reaction may be permitted to proceed in an extruder for about 3-5 minutes at a temperature of about 250 to 280° C.

Suitable polyester copolymer comprising predominantly polyester segments and an oxygen scavenging amount of polyolefin oligomer segments are available commercially under the trademark AMOSORB DFC or AMOSORB 3000 from BP Chemical.

The polyester copolymer comprising predominantly polyester segments and an oxygen scavenging amount of polyolefin oligomer segments may be extruded into suitable forms to be accommodated into a tire. For example, the copolymer may be extruded or blown into a thin film suitable for interlaminar placement in a tire. Such placement may include disposing the oxygen scavenging barrier as one layer in a multi-layer innerliner, in the manner disclosed in any of U.S. Pat. Nos. 5,292,590; 5,992,486; or 5,178,702, all incorporated herein by reference. Alternatively, such placement may include disposing the oxygen scavenging barrier between the carcass ply and belt layers, between belt layers and tread, around the turnup end of the carcass ply or the ends of the belts, or any combination of these. The use of appropriate adhesives is contemplated to ensure compatibility between the oxygen scavenging barrier and rubber compounds in the tire. Such adhesives may include, for example, conventional RFL adhesives as are known in the art. Adhesives may be applied as a layer between the oxygen scavenging barrier and adjacent rubber compounds.

The film used as the oxygen scavenging barrier may include additional transition metal catalyst as further oxygen scavenger. Such use of additional transition metal catalyst is in addition to that used as a transesterification catalyst. Additional transition metal catalyst includes cobalt, iron, and manganese catalysts, as are known in the art, in an amount ranging from about 10 to 2000 ppm. The oxygen scavenging barrier may further include additives as are known in the art, including plasticizers to impart the desired level of flexibility in the film.

Various components of the tire susceptible to degradation and aging due to oxidation and/or ozonation may comprise the polyester copolymer comprising predominantly polyester segments and an oxygen scavenging amount of polyolefin oligomer segments. The components include, but are not limited to, the innerliner, the carcass ply, and the belts. In one embodiment, a thin layer of the polyester copolymer, comprising predominantly polyester segments and an oxygen scavenging amount of polyolefin oligomer segments, may be disposed adjacent to and surrounding the belt edges and/or carcass ply endings to prevent migration of oxygen to the belts and plies. In another embodiment, one or more thin layers of the polyester copolymer comprising predominantly polyester segments and an oxygen scavenging amount of polyolefin oligomer segments may be incorporated into a multi-layer innerliner structure to reduce or eliminate migration of oxygen from the inflation air of the tire into the various components of the tire.

In practice, various rubber compositions are used to form a laminate in the building of a tire. As known to those skilled in the art, the layers are produced by a press or passing a rubber composition through a mill, calender multi-head extruder or other suitable means. Preferably, a calender produces the layers because greater uniformity is believed to be provided. The layers are then assembled into a laminate. The uncured laminate is then constructed as an uncured rubber tire structure, also known as the carcass. The carcass is then sulfur cured during the tire curing operation under conditions of heat and pressure. Vulcanization of the tire of the present invention is generally carried out at temperatures of between about 100° C. and 200° C. Preferably, the vulcanization is conducted at temperatures ranging from about 110° C. to 180° C. Any of the usual vulcanization processes may be used such as heating in a press or mold, heating with superheated steam or hot salt or in a salt bath. Preferably, the heating is accomplished in a press or mold in a method known to those skilled in the art of tire curing.

The pneumatic tire with the oxygen scavenging barrier may be constructed in the form of a passenger tire, truck tire, or other type of bias or radial pneumatic tire.

While certain representative embodiments and details have been shown for the purpose of illustrating the invention, it will be apparent to those skilled in this art that various changes and modifications may be made therein without departing from the spirit or scope of the invention.

What is claimed is:

1. A pneumatic tire comprising at least one oxygen scavenging barrier, the barrier comprising a polyester copolymer, said polyester copolymer comprising a copolycondensate of a polyester and a polyolefin oligomer.

2. The tire of claim 1, wherein said polyester is selected from polyethylene terephthalate, polybutylene terephthalate, polybutylene terephthalate elastomer, amorphous polyesters, polycyclohexane terephthalate, polyethylene naphthalate, and polybutylene naphthalate.

3. The pneumatic tire of claim 1, wherein said polyolefin oligomer is selected from the group consisting of polyolefin and polydienes.

4. The pneumatic tire of claim 1, wherein said polyolefin oligomer is selected from the group consisting of polypropylene, poly(4-methyl)1-pentene and polybutadiene.

5. The pneumatic tire of claim 1, wherein polyolefin oligomer segments of said polycondensate comprise from about 0.5 weight percent to about 12 weight percent based on the weight of the copolycondensate.

6. The pneumatic tire of claim 1, wherein polyolefin oligomer segments of said polycondensate comprise from about 2 weight percent to about 8 weight percent based on the weight of the copolycondensate.

7. The pneumatic tire of claim 1, wherein polyolefin oligomer segments of said polycondensate comprise from about 2 weight percent to about 6 weight percent based on weight of the copolycondensate.

8. The pneumatic tire of claim 1, wherein said polyolefin oligomer has a molecular weight ranging from 100 to 10,000.

9. The tire of claim 1, wherein said oxygen scavenging barrier is disposed as a layer laminated over a belt edge of said tire.

10. The tire of claim 1, wherein said oxygen scavenging barrier is disposed as a layer laminated over a carcass ply end of said tire.

11. The tire of claim 1, wherein said oxygen scavenging barrier is disposed as a layer in a multi-layer innerliner of said tire.

12. The tire of claim 1, wherein said oxygen scavenging barrier is disposed as a layer in a sidewall of said tire.

13. The tire of claim 1, wherein said oxygen scavenging barrier is disposed as a plurality of layers in an innerliner of said tire.

14. The tire of claim 1, wherein said oxygen scavenging barrier is disposed as a plurality of layers in a sidewall of said tire.

15. The tire of claim 1, wherein said oxygen scavenging barrier further comprises from 10 to 2000 ppm of a transition metal catalyst.

16. The tire of claim 1, wherein said oxygen scavenging barrier further comprises from 10 to 2000 ppm of a transition metal catalyst selected from cobalt catalysts, iron catalysts, and manganese catalysts.
